(19) United States
(12) Patent Application Publication
(10) Pub. No.: US 2024/0383053 A1
(43) Pub. Date: Nov. 21, 2024

(54) WHEELED OSCILLATING BLADE DEVICE

(71) Applicant: Maria Poteet, Camarillo, CA (US)

(72) Inventor: Maria Poteet, Camarillo, CA (US)

(21) Appl. No.: 18/198,821

(22) Filed: May 17, 2023

(51) Int. Cl. B23D 49/00; B25F 5/02

(52) U.S. Cl. CPC B23D 49/001; B25F 5/02

(57) ABSTRACT

A wheeled oscillating blade device for pushing an oscillating blade on wheels to facilitate removing materials from the ground surface includes a housing. A pair of wheels is rotatably coupled to the housing to facilitate pushing and pulling the housing on a ground surface. A motor is positioned within the housing, and a shaft extends out from the motor. The motor rotates the shaft in an oscillating motion when the motor is turned on. A blade mount is positioned within the bottom opening and is in mechanical communication with the shaft, wherein the shaft oscillates the blade mount when the motor is turned on. A blade is mounted to the blade mount, wherein the blade oscillates when the motor is turned on. The oscillating motion of the blade facilitates removing materials from the ground surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to power tool and more particularly pertains to a new power tool for pushing an oscillating blade on wheels to facilitate removing materials from the ground surface.

### (2) Description of Related Art Including Information Disclosed Under 37 CFR 1.97 and 1.98

The prior art relates to power tools and includes a variety of power tools oscillating a blade when the power tool is turned on. Known prior art does not include a power tool oscillating a blade and having a pair of wheels such that the blade is movable adjacent to a ground surface as the power tool is pushed forward on the wheels.

### BRIEF SUMMARY OF THE INVENTION

An embodiment of the disclosure meets the needs presented above by generally comprising a housing including a bottom wall, a front wall, a back wall, a pair of side walls, and a top wall. The bottom wall has a bottom opening extending therethrough and into the housing. A pair of wheels is rotatably coupled to the housing and is configured to facilitate pushing and pulling the housing on a ground surface. A motor is positioned within the housing, and a shaft extends out from the motor. The motor rotates the shaft in an oscillating motion when the motor is turned on. A gear is coupled to the shaft of the motor. The gear is a toothed wheel, and the shaft extends through a center of the gear, wherein the gear is fixed to the shaft such that the gear oscillates when the motor is turned on. A blade mount is positioned within the bottom opening. A top surface of the blade mount is toothed, wherein the top surface is engaged with the gear such that the blade mount oscillates when the motor is turned on. A blade is mounted to the blade mount. A power supply is electrically coupled to the motor. A switch is electrically coupled to the motor and is engaged to turn on or off the motor. An elongated member extends outwardly from the housing. The elongated member has a first end and a second end, and the second end defines a grip for the elongated member, wherein the grip is configured to be grabbed by a user to push and pull the housing on the wheels.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a wheeled oscillating blade device according to an embodiment of the disclosure.

FIG. 2 is a front view of an embodiment of the disclosure.

FIG. 3 is a cross-sectional view of an embodiment of the disclosure taken along Line 3-3 of FIG. 2.

FIG. 4 is a side view of an embodiment of the disclosure.

FIG. 5 is an exploded cross-sectional view of an embodiment of the disclosure taken along Line 5-5 of FIG. 4.

FIG. 6 is a rear isometric view of an embodiment of the disclosure.

FIG. 7 is a bottom view of an embodiment of the disclosure.

FIG. 8 is an in-use view of an embodiment of the disclosure.

FIG. 9 is a top isometric view of an alternative embodiment of the disclosure.

FIG. 10 is a bottom view of an alternative embodiment of the disclosure.

### DETAILED DESCRIPTION OF THE INVENTION

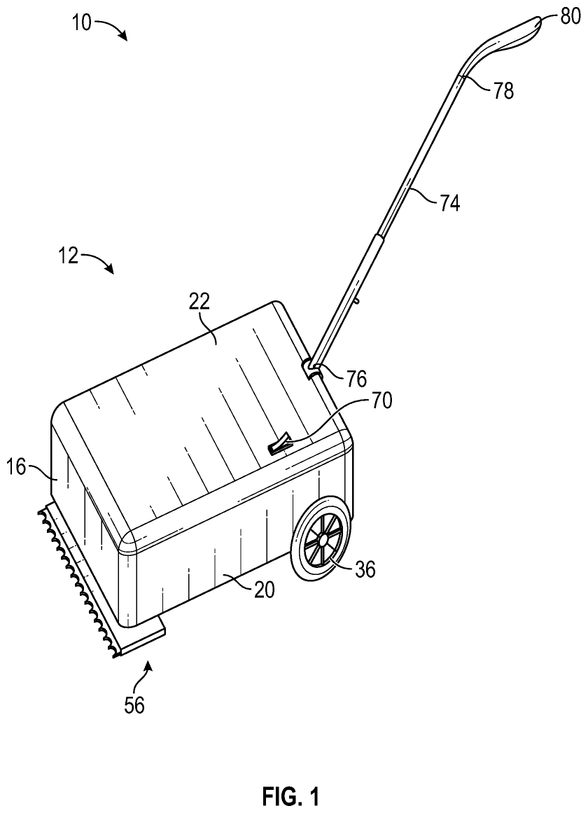

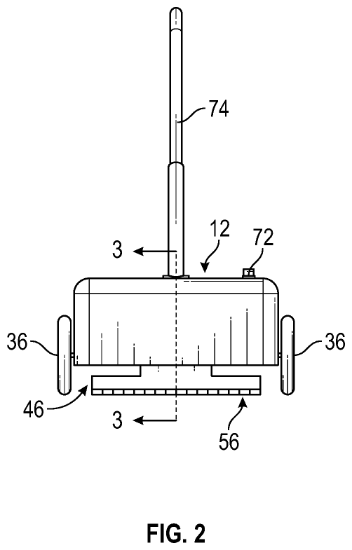

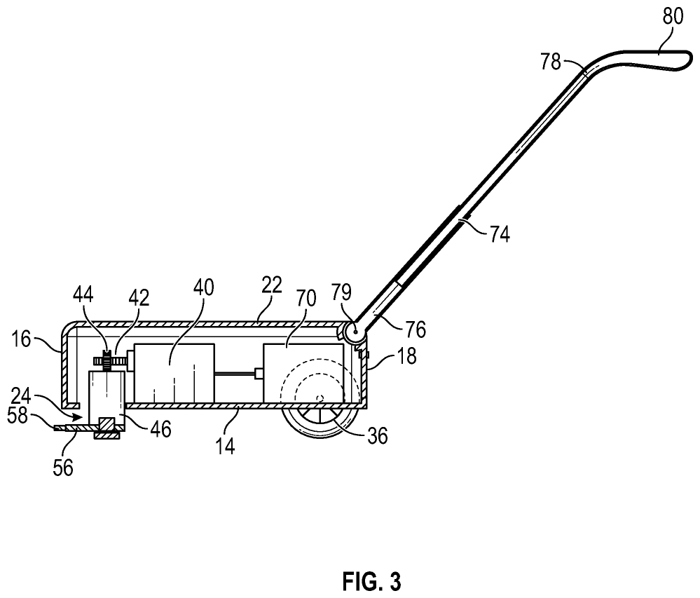

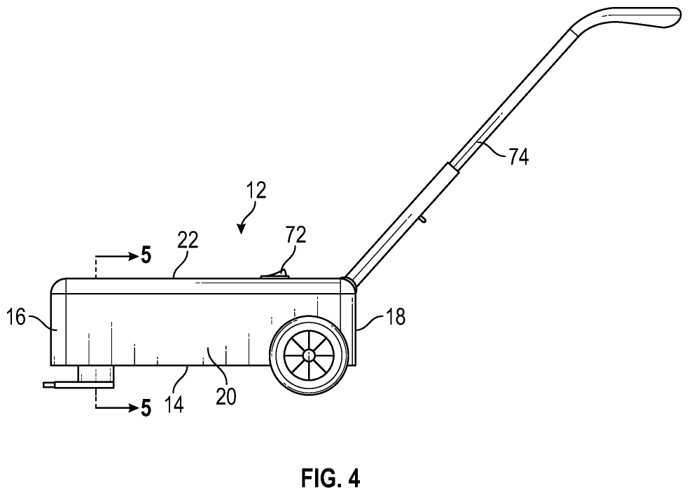

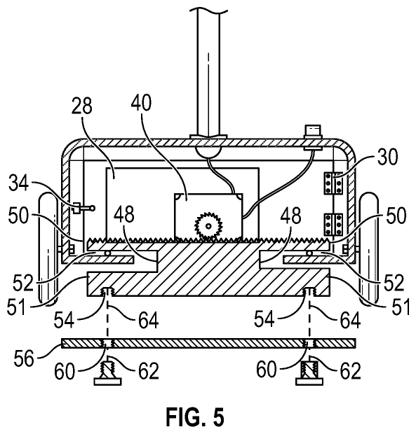

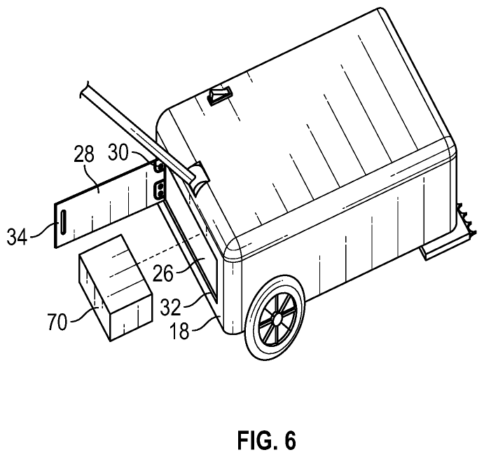

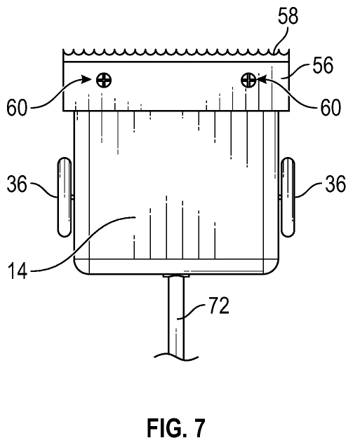

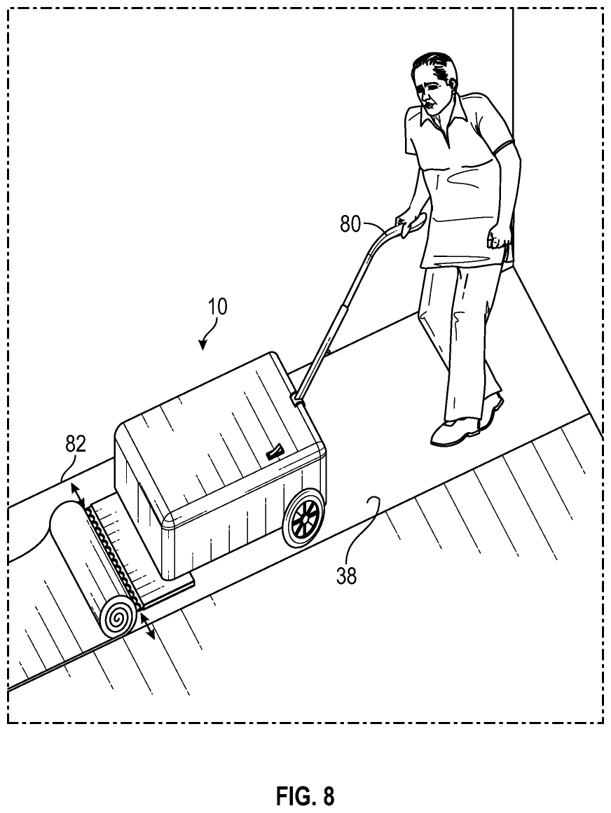

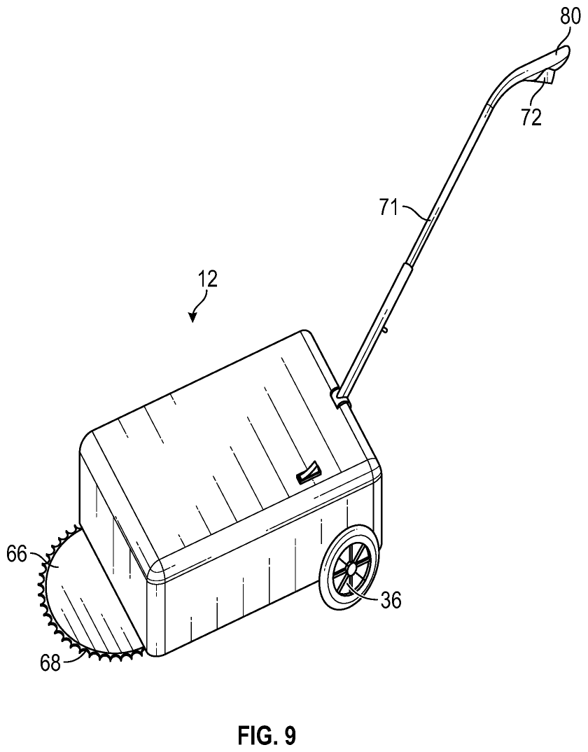

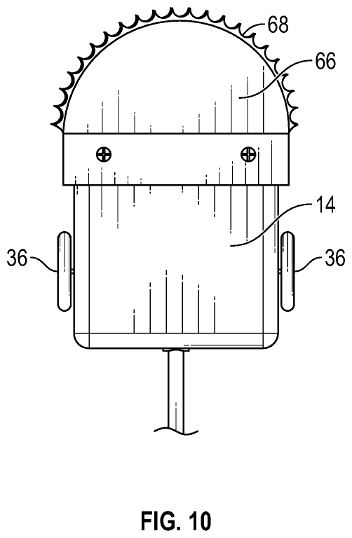

With reference now to the drawings, and in particular to FIGS. 1 through 10 thereof, a new power tool embodying the principles and concepts of an embodiment of the disclosure and generally designated by the reference numeral 10 will be described.

As best illustrated in FIGS. 1 through 10, the wheeled oscillating blade device 10 generally comprises a housing 12 including a bottom wall 14, a front wall 16, a back wall 18, a pair of side walls 20, and a top wall 22. The bottom wall 14 has a bottom opening 24 extending therethrough and into the housing 12. The back wall 18 has a back opening 26 extending therethrough and into the housing 12. A door 28 may be pivotally attached by a hinge 30 to a peripheral edge 32 of the back opening 26 such that the door 28 may be positioned to close the back opening 26. The door 28 may have a latching member 34 to secure the door 28 in a closed position when the door 28 closes the back opening 26. A pair of wheels 36 is rotatably coupled to the housing 12 and is configured to facilitate pushing and pulling the housing 12 on a ground surface 38. Each of the wheels 36 are rotatably coupled to a respective one of the pair of side walls 20. The pair of wheels 36 is positioned proximate to the back wall 18 and to the bottom wall 14.

A motor 40 is positioned within the housing 12, and a shaft 42 extends out from the motor 40. The motor 40 rotates the shaft 42 in an oscillating motion when the motor 40 is turned on. The shaft 42 is positioned above the bottom opening 24 of the bottom wall 14. A gear 44 is coupled to the shaft 42 of the motor 40. The gear 44 is a toothed wheel, and the shaft 42 extends through a center of the gear 44, wherein the gear 44 is fixed to the shaft 42 such that the gear 44 oscillates when the motor 40 is turned on.

A blade mount 46 is positioned within the bottom opening 24. The blade mount 46 has a pair of lateral ends 48. Each of the lateral ends 48 has a respective one of a pair of upper protrusions 50 and a respective one of a pair of lower protrusions 51 extending outwardly therefrom. Each of the lower protrusions 51 are positioned beneath the bottom wall 14. The lower protrusions 51 elongate a bottom surface of the blade mount 46. Each of the upper protrusions 50 are coupled onto the bottom wall 14 by a pair of rolling members 52, wherein the pair of rolling members 52 slide the pair of upper protrusions 50 upon the bottom wall 14 when the motor 40 oscillates the blade mount 46. A top surface of the blade mount 46 is toothed, wherein the top surface is engaged with the gear 44 such that the blade mount 46 oscillates when the motor 40 is turned on.

The bottom surface of the blade mount 46 has a pair of holes 54 extending therethrough. A blade 56 is mounted to the blade mount 46. The blade 56 is a plate having an upper surface, a lower surface, and a front edge. The front edge is serrated to define a cutting edge 58 configured to saw through objects. The blade 56 has a pair of apertures 60 extending through the upper surface and the lower surface. Each of the apertures 60 has equal diameters with a respective one of the pair of holes 54. The upper surface of the blade 56 abuts the bottom surface of the blade mount 46 and a middle axis 62 of each of the apertures 60 aligns with a center axis 64 of each of the holes 54. A pair of bolts is inserted through a respective one of the pair of apertures 60 of the blade 56 and into a respective one of the pair of holes 54 the blade mount 46 to secure the blade 56 to the blade mount 46. The blade 56 is removeable from the blade mount 46 so that an alternative blade 66 may be mounted to the blade mount 46. A forward edge 68 of the alternative blade 66 is serrated and convexly arcuate to facilitate scraping adhesives from the ground surface 38.

A power supply 70 is electrically coupled to the motor 40. The power supply 70 is a replaceable battery, wherein the power supply 70 is removable from the housing 12 through the back opening 26. The replaceable battery typically comprises a lithium battery. A switch 72 is electrically coupled to the motor 40 and is engaged to turn on or off the motor 40. The switch 72 is mounted to the top wall 22 of the housing 12. An elongated member 74 extends outwardly from the housing 12. The elongated member 74 has a first end 76 and a second end 78. The first end 76 is pivotally coupled to a juncture of the top wall 22 and the back wall 18 by a pivoting pin 79. The second end 78 defines a grip 80 for the elongated member 74, wherein the grip 80 is configured to be grabbed by a user to push and pull the housing 12 on the wheels 36. The elongated member 74 is telescopic, wherein a length from the first end 76 to the second end 78 is adjustable. Alternatively, the switch 72 may be mounted to the grip 80 of the elongated member 74, wherein the user may turn on and off the motor 40 when holding the grip 80.

In use, the blade 56 is secured to the blade mount 46 with the pair of bolts 62. The switch 72 is engaged to turn on the motor 40 so that the blade 56 begins to oscillate. The user grabs the grip 80 of the elongated member 74 and pushes the elongated member 74 forward such that the housing 12 and the blade 56 are pushed forward. The blade 56 may oscillate between a carpet 82 and the ground surface 38 to scrape away any adhesive holding the carpet 82 to the ground surface 38 as the blade 56 is pushed forward.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheeled power tool device comprising:
a housing including a bottom wall, a front wall, a back wall, a pair of side walls, and a top wall, said bottom wall has a bottom opening extending therethrough and into said housing;
a pair of wheels being rotatably coupled to said housing, said pair of wheels being configured to facilitate pushing and pulling said housing on a ground surface;
a motor being positioned within said housing, a shaft extending out from said motor, said motor rotating said shaft in an oscillating motion when said motor is turned on;
a gear being coupled to said shaft of said motor, said gear being a toothed wheel, said shaft extending through a center of said gear, wherein said gear is fixed to said shaft such that said gear oscillates when said motor is turned on;
a blade mount being positioned within said bottom opening, a top surface of said blade mount being toothed, wherein said top surface is engaged with said gear such that said blade mount oscillates when said motor is turned on;
a blade being mounted to said blade mount;
a power supply being electrically coupled to said motor;
a switch being electrically coupled to said motor, said switch being engaged to turn on or off said motor; and
an elongated member extending outwardly from said housing, said elongated member having a first end and a second end, said second end defining a grip for said elongated member, wherein said grip is configured to be grabbed by a user to push and pull said housing on said wheels.

2. The wheeled power tool device of claim 1, wherein said back wall has a back opening extending therethrough and into said housing.

3. The wheeled power tool device of claim 1, wherein each of said wheels is rotatably coupled to a respective one of said pair of side walls, said pair of wheels being positioned proximate to said back wall and to said bottom wall.

4. The wheeled power tool device of claim 1, wherein said shaft is positioned above said bottom opening of said bottom wall.

5. The wheeled power tool device of claim 1, wherein a bottom surface of said blade mount having a pair of holes extending therethrough.

6. The wheeled power tool device of claim 5, wherein said blade being a plate having an upper surface, a lower surface, and a front edge, said front edge being serrated to define a cutting edge configured to saw through objects, said blade having a pair of apertures extending through said upper surface and said lower surface, each of said apertures having equal diameters with a respective one of said pair of holes.

7. The wheeled power tool device of claim 2, wherein said power supply being a replaceable battery, wherein said power supply is removable from said housing through said back opening.

8. The wheeled power tool device of claim 1, wherein said switch being mounted to said top wall of said housing.

9. The wheeled power tool device of claim 1, wherein said first end being pivotally coupled to a juncture of said top wall and said back wall, said elongated member being telescopic, wherein a length from said first end to said second end is adjustable.

10. A wheeled power tool device comprising:
a housing including a bottom wall, a front wall, a back wall, a pair of side walls, and a top wall, said bottom wall having a bottom opening extending therethrough and into said housing, said back wall having a back opening extending therethrough and into said housing;
a pair of wheels being rotatably coupled to said housing, said pair of wheels being configured to facilitate pushing and pulling said housing on a ground surface, each of said wheels being rotatably coupled to a respective one of said pair of side walls, said pair of wheels being positioned proximate to said back wall and to said bottom wall;
a motor being positioned within said housing, a shaft extending out from said motor, said motor rotating said shaft in an oscillating motion when said motor is turned on, said shaft being positioned above said bottom opening of said bottom wall;
a gear being coupled to said shaft of said motor, said gear being a toothed wheel, said shaft extending through a center of said gear, wherein said gear is fixed to said shaft such that said gear oscillates when said motor is turned on;
a blade mount being positioned within said bottom opening, a top surface of said blade mount being toothed, wherein said top surface is engaged with said gear such that said blade mount oscillates when said motor is turned on, a bottom surface of said blade mount having a pair of holes extending therethrough;
a blade being mounted to said blade mount, said blade being a plate having an upper surface, a lower surface, and a front edge, said front edge being serrated to define a cutting edge configured to saw through objects, said blade having a pair of apertures extending through said upper surface and said lower surface, each of said apertures having equal diameters with a respective one of said pair of holes;
a power supply being electrically coupled to said motor, said power supply being a replaceable battery, wherein said power supply is removable from said housing through said back opening;
a switch being electrically coupled to said motor, said switch being engaged to turn on or off said motor, said switch being mounted to said top wall of said housing; and
an elongated member extending outwardly from said housing, said elongated member having a first end and a second end, said first end being pivotally coupled to a juncture of said top wall and said back wall, said second end defining a grip for said elongated member, wherein said grip is configured to be grabbed by a user to push and pull said housing on said wheels, said elongated member being telescopic, wherein a length from said first end to said second end is adjustable.
